(19) United States
(12) Patent Application Publication
(10) Pub. No.: US 2023/0413046 A1
(43) Pub. Date: Dec. 21, 2023

(54) AUTHENTICATION PROCEDURE

(71) Applicant: Nokia Technologies Oy, Espoo (FI)

(72) Inventors: Peter SCHNEIDER, Holzkirchen (DE); Markus STAUFER, Munich (DE); Ranganathan MAVUREDDI DHANASEKARAN, Munich (DE)

(21) Appl. No.: 18/334,794

(22) Filed: Jun. 14, 2023

Related U.S. Application Data
(60) Provisional application No. 63/352,424, filed on Jun. 15, 2022.

(51) Int. Cl. H04W 12/06; H04W 40/22; H04W 12/08; H04W 12/033

(52) U.S. Cl. CPC H04W 12/06; H04W 12/033; H04W 12/08; H04W 40/22

(57) ABSTRACT

According to an example aspect of the present invention, there is provided an apparatus, such as a user equipment, configured to transmit to a cellular core network a request to open a protocol session to an external network which is external to the cellular core network, the request being configured to cause the cellular core network to transmit to the external network, or to receive from the external network, a code associated with a subscription of the apparatus, forward at least one authentication request originating in the external network to a node connected with the apparatus, via a local connection, and forward at least one authentication response from the node to the external network via the cellular core network, and relay packets comprised in the protocol session between the node and the external network without participating in the protocol session as an endpoint.

### FIELD

The present disclosure relates to security procedures in communication solutions, such as communication networks, for example.

### BACKGROUND

Networking between disparate communication networks may be accomplished using various technical mechanisms, including gateways and authentication processes. In detail, a cellular communication network may be configured to interface with a network external to the cellular communication network via a core network of the cellular communication network. Further, the cellular communication network may be configured to interface with a personal network of a user via a radio-access network of the cellular communication network, and a user equipment of the user.

### SUMMARY

According to some aspects, there is provided the subject-matter of the independent claims. Some embodiments are defined in the dependent claims. The scope of protection sought for various embodiments of the invention is set out by the independent claims. The embodiments, examples and features, if any, described in this specification that do not fall under the scope of the independent claims are to be interpreted as examples useful for understanding various embodiments of the invention.

According to a first aspect of the present disclosure, there is provided an apparatus comprising at least one processing core, at least one memory including computer program code, the at least one memory and the computer program code being configured to, with the at least one processing core, cause the apparatus at least to transmit to a cellular core network a request to open a protocol session to an external network which is external to the cellular core network, the request being configured to cause the cellular core network to transmit to the external network, or to receive from the external network, a code associated with a subscription of the apparatus, forward at least one authentication request originating in the external network to a node connected with the apparatus, via a local connection, and forward at least one authentication response from the node to the external network via the cellular core network, and relay packets comprised in the protocol session between the node and the external network without participating in the protocol session as an endpoint.

According to a second aspect of the present disclosure, there is provided an apparatus comprising at least one processing core, at least one memory including computer program code, the at least one memory and the computer program code being configured to, with the at least one processing core, cause the apparatus at least to receive from a cellular core network a message comprising an identity of a node connected via a cellular user equipment, and process a code associated with a subscription of the user equipment, verify, based on the code, whether the node is allowed to access a network wherein the apparatus is comprised via the user equipment, perform at least one authentication exchange with the node via the cellular core network and the user equipment, and responsive to the verification indicating the node is allowed to access the network via the user equipment and the at least one authentication exchange succeeding, transmit an indication of authentication success to the cellular core network.

According to a third aspect of the present disclosure, there is provided an apparatus comprising at least one processing core, at least one memory including computer program code, the at least one memory and the computer program code being configured to, with the at least one processing core, cause the apparatus at least to receive a request to open a protocol session to an external network which is external to a cellular core network where the apparatus is comprised, the request identifying a user equipment, verify, based on subscription data associated with the user equipment, whether the user equipment is allowed to act as gateway toward the external network, and transmit a code associated with the subscription of the user equipment toward the external network responsive to the verifying indicating the user equipment is allowed to act as the gateway toward the external network, or receive the code from the external network for verifying that an authentication involving the external network is successful.

According to a fourth aspect of the present disclosure, there is provided a method comprising transmitting, from an apparatus, to a cellular core network a request to open a protocol session to an external network which is external to the cellular core network, the request being configured to cause the cellular core network to transmit to the external network, or to receive from the external network, a code associated with a subscription of the apparatus, forwarding at least one authentication request originating in the external network to a node connected with the apparatus, via a local connection, and forwarding at least one authentication response from the node to the external network via the cellular core network, and relaying packets comprised in the protocol session between the node and the external network without participating in the protocol session as an endpoint.

According to a fifth aspect of the present disclosure, there is provided a method, comprising receiving from a cellular core network a message comprising an identity of a node connected via a cellular user equipment, and process a code associated with a subscription of the user equipment, verifying, based on the code, whether the node is allowed to access a network wherein the apparatus is comprised via the user equipment, performing at least one authentication exchange with the node via the cellular core network and the user equipment, and responsive to the verification indicating the node is allowed to access the network via the user equipment and the at least one authentication exchange succeeding, transmitting an indication of authentication success to the cellular core network.

According to a sixth aspect of the present disclosure, there is provided an apparatus comprising means for transmitting, from the apparatus, to a cellular core network a request to open a protocol session to an external network which is external to the cellular core network, the request being configured to cause the cellular core network to transmit to the external network, or to receive from the external network, a code associated with a subscription of the apparatus, forwarding at least one authentication request originating in the external network to a node connected with the apparatus, via a local connection, and forwarding at least one authentication response from the node to the external network via the cellular core network, and relaying packets comprised in the protocol session between the node and the external network without participating in the protocol session as an endpoint.

According to a seventh aspect of the present disclosure, there is provided an apparatus comprising means for receiving from a cellular core network a message comprising an identity of a node connected via a cellular user equipment, and process a code associated with a subscription of the user equipment, verifying, based on the code, whether the node is allowed to access a network wherein the apparatus is comprised via the user equipment, performing at least one authentication exchange with the node via the cellular core network and the user equipment, and responsive to the verification indicating the node is allowed to access the network via the user equipment and the at least one authentication exchange succeeding, transmitting an indication of authentication success to the cellular core network.

According to an eighth aspect of the present disclosure, there is provided a non-transitory computer readable medium having stored thereon a set of computer readable instructions that, when executed by at least one processor, cause an apparatus to at least transmit to a cellular core network a request to open a protocol session to an external network which is external to the cellular core network, the request being configured to cause the cellular core network to transmit to the external network, or to receive from the external network, a code associated with a subscription of the apparatus, forward at least one authentication request originating in the external network to a node connected with the apparatus, via a local connection, and forward at least one authentication response from the node to the external network via the cellular core network, and relay packets comprised in the protocol session between the node and the external network without participating in the protocol session as an endpoint.

According to a ninth aspect of the present disclosure, there is provided a non-transitory computer readable medium having stored thereon a set of computer readable instructions that, when executed by at least one processor, cause an apparatus to at least receive from a cellular core network a message comprising an identity of a node connected via a cellular user equipment, and process a code associated with a subscription of the user equipment, verify, based on the code, whether the node is allowed to access a network wherein the apparatus is comprised via the user equipment, perform at least one authentication exchange with the node via the cellular core network and the user equipment, and responsive to the verification indicating the node is allowed to access the network via the user equipment and the at least one authentication exchange succeeding, transmit an indication of authentication success to the cellular core network.

According to a tenth aspect of the present disclosure, there is provided a computer program configured to cause a device to perform at least the following, when run: transmit to a cellular core network a request to open a protocol session to an external network which is external to the cellular core network, the request being configured to cause the cellular core network to transmit to the external network, or to receive from the external network, a code associated with a subscription of the apparatus, forward at least one authentication request originating in the external network to a node connected with the apparatus, via a local connection, and forward at least one authentication response from the node to the external network via the cellular core network, and relay packets comprised in the protocol session between the node and the external network without participating in the protocol session as an endpoint.

According to an eleventh aspect of the present disclosure, there is provided a computer program configured to cause a device to perform at least the following, when run: receive from a cellular core network a message comprising an identity of a node connected via a cellular user equipment, and process a code associated with a subscription of the user equipment, verify, based on the code, whether the node is allowed to access a network wherein the apparatus is comprised via the user equipment, perform at least one authentication exchange with the node via the cellular core network and the user equipment, and responsive to the verification indicating the node is allowed to access the network via the user equipment and the at least one authentication exchange succeeding, transmit an indication of authentication success to the cellular core network.

### BRIEF DESCRIPTION OF THE DRAWINGS

FIG. 1 illustrates an example system in accordance with at least some embodiments of the present invention;

FIG. 2A illustrates an example process capable of supporting at least some embodiments of the present invention;

FIG. 2B illustrates an example process capable of supporting at least some embodiments of the present invention;

FIG. 3 illustrates an example apparatus capable of supporting at least some embodiments of the present invention;

FIG. 4 illustrates signalling in accordance with at least some embodiments of the present invention, and

FIG. 5 is a flow graph of a method in accordance with at least some embodiments of the present invention.

### EMBODIMENTS

Methods are disclosed herein to enable an authentication mechanism to enable a node connected via a user equipment to form a protocol session between itself and a network external to a cellular communication system where the user equipment is attached. The node and the external network are endpoints of the protocol session, that is, they implement the protocol mechanisms to maintain and, eventually, tear down the protocol session. The user equipment and cellular communication system forward packets of the protocol session without participating in the protocol session as endpoints. In detail, the user equipment forwards authentication messages from the external network to the node, and from the node toward the external network. A subscription of the user equipment in the cellular communication network is furnished with a code, such as an authorization code to enable the user equipment to invoke establishment of the protocol session for the node connected via the user equipment.

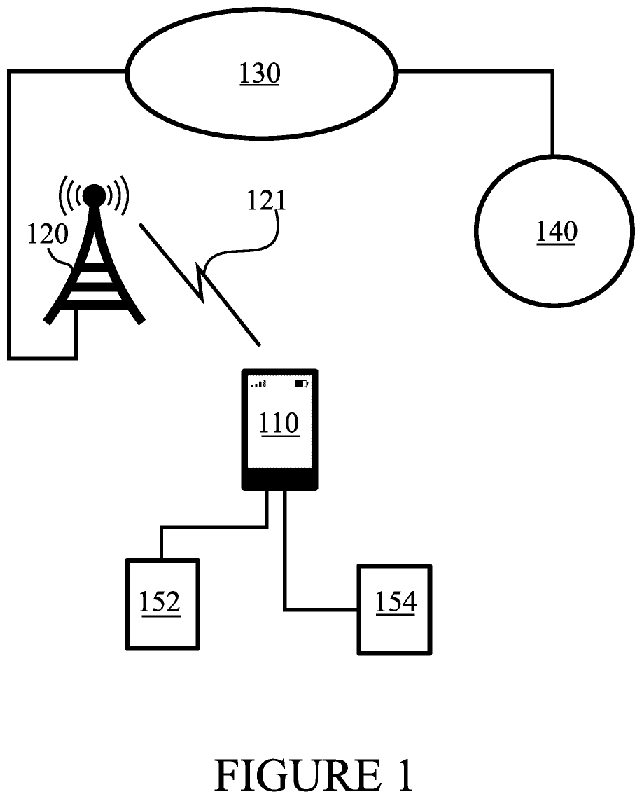

FIG. 1 illustrates an example system in accordance with at least some embodiments of the present invention. A cellular communication system comprises a radio-access network and a cellular core network 130. The radio-access network comprises at least one base station 120, typically it comprises several hundred or even several thousand base stations. Base stations may be configured to control at least one cell each. Examples of cellular communication systems include fifth generation, 5G, systems, wideband code division multiple access, WCDMA, systems and long term evolution, LTE, systems.

User equipment, UE, 110 is communicatively coupled with base station 120 via wireless link 121, which conforms to a same communication standard as UE 110 and base station 120, to achieve interoperability. UE 110 may comprise a smartphone, a cellular phone, a tablet, laptop or desktop computer or, for example, a connected car communication module, as applicable. UE 110 acts as a gateway for local nodes 152 and 154, which are coupled with UE 110 via a short-range connection, such as a cable or a wireless connection. Examples of suitable wireless connections include Bluetooth and wireless local area network, WLAN. Bluetooth is a wireless technology where communication takes place between 2.402 GHz and 2.48 GHz. The local nodes 152 and 154 may be considered personal internet of things, IoT, elements, PEs. The set of local nodes 152, 154 together with UE 110 form a personal IoT network, PIN. The UE 110 itself, in the PIN, is a PIN element with gateway capabilities, PEGC.

A PIN may serve one or more specific purposes, and local nodes 152, 154 may need to connect to specific application servers for these purposes. These application servers may be in networks, NW, external to the cellular communication system. An organisation providing these application servers may be referred to as a PIN application service provider, PSP. The application servers of the PSP may form a data network 140 in the sense of 3^{rd} generation partnership project, 3GPP, specifications, connected, for example via an N6 interface as specified by 3GPP, to the cellular core network 130. Also other interconnection mechanisms between network 140 and core network 130 may alternatively or additionally be used. Herein network 140 will be referred to as external network 140, since it is external to and distinct from the cellular communication system, including cellular core network 130. Local nodes 152, 154 may reach servers in external network 140 via PEGC/UE 110, base station 120 and cellular core network 130.

When local nodes 152, 154 connect to application servers in external network 140, authentication, key agreement and use of cryptographic traffic protection is useful end-to-end between local nodes 152, 154 and external network 140. This requires that credentials are shared between the local nodes and the external network 140. Such credentials may be preconfigured in the local nodes 152, 154 or created by the PIN owner in local nodes 152, 154 and shared with the PSP via an out-of-band channel, such as via a secure access to an Internet portal of the PSP, for example. It is an important security feature that these credentials must not be shared with UE 110, as the UE is not under control of the PSP. The secure out-of-band channel can also be used to convey information to the PSP concerning which local nodes 152, 154 are part of a PIN, and which UE(s) will be used in this PIN as PEGCs. It is further useful, if a PIN can connect to more than one external network 140, to enhance versatility of service access. Additionally to security mechanisms between local nodes 152, 154 and external network 140, UE 110 has a range of cellular security procedures with cellular core network 130, in particular primary authentication based on the credentials in the PEGC/UE 110's universal subscriber identity module, USIM, and the core NW's authentication credential repository and processing function, ARPF.

Overall, a problem presents itself in how can it be ensured that authorized local nodes 152, 154 can securely connect via the PEGC/UE 110 and the core network 130 to the external networks 140 of authorized PSPs, while preventing abuse of connectivity through PEGC/UE 110 and core network 130 by unauthorized local nodes and/or unauthorized PSPs.

The mechanism disclosed herein to solve, at least in part, the problem identified above is based on the following principles: The PEGC/UE 110 initially connects to the cellular core network 130 using a normal, existing cellular authentication mechanism. When a local node 152, 154 requires connectivity to a PSP's external network 140, the PEGC/UE 110 uses non-access stratum, NAS, for example, to trigger the establishment of a packet data unit, PDU, or other protocol session toward external network 140. Subscription data of the PEGC/UE 110 is checked to verify, whether PEGC/UE 110 is authorized to connect to external network 140, and secondary authentication is triggered by the core network. The secondary authentication comprises the following features. Firstly, the PEGC/UE 110 does not itself perform the secondary authentication with the external network, but it relays at least one message comprised in the secondary authentication process to and from the local node 152, 154. Secondly, the cellular core network, when transmitting a message towards the external network, adds a code, such as an authorization code, from PEGC/UE 110's subscription data to the message. Thirdly, external network 140 considers the secondary authentication as successful, if according to stored authorization information in external network 140, local node 152, 154 is authorized to use the PEGC/UE 110 with the received authorization code, and the authentication exchange between external network 140 and local node 152, 154 is successful. The authentication exchange between external network 140 and local node 152, 154 may establish cryptographic information used to secure the protocol session between the local node and the external network. Fourthly, in a successful secondary authentication, cryptographic information is established between local node 152, 154 and external network 140 that can be subsequently used to secure the protocol session, such as packet data unit, PDU, session.

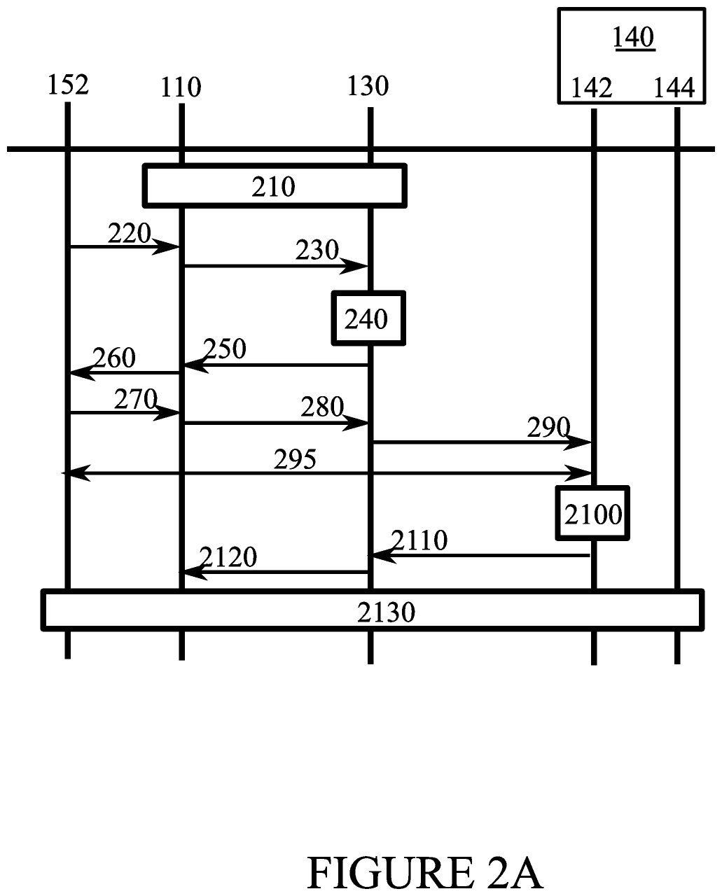

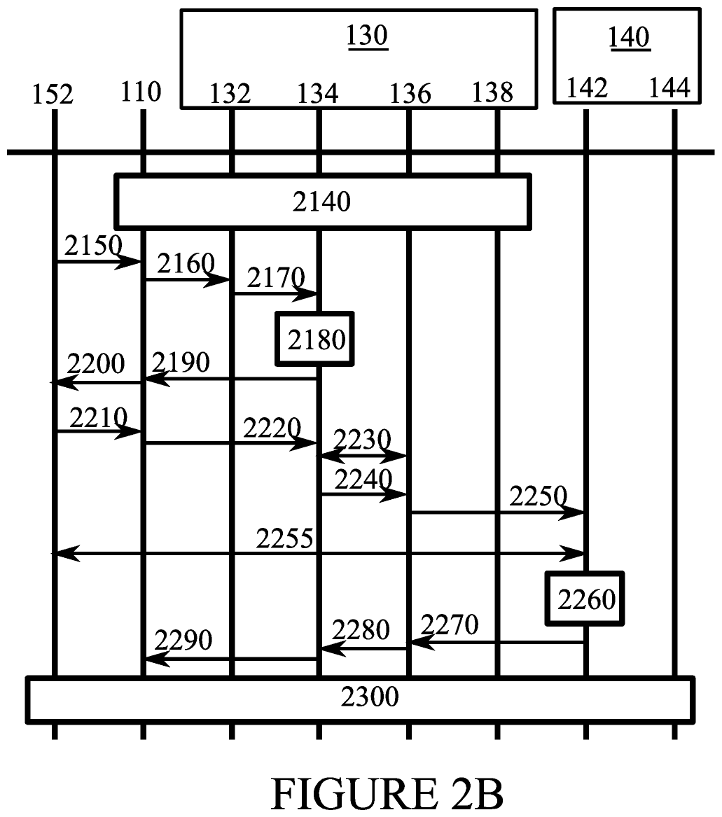

FIG. 2A illustrates an example process capable of supporting at least some embodiments of the present invention. On the vertical axes are disposed, from the left to the right, local node 152, PEGC/UE 110, core network, NW, 130, and on the right external network 140, wherein are comprised authentication server 142 and application server 144. Time advances from the top toward the bottom. The following is assumed as prerequisites for this flow. The PEGC/UE's subscription data comprises an indication that the PEGC/UE is allowed to connect to the external network and that secondary authentication is required for that. The PEGC/UE's subscription data comprise an authorization code for the PSP. In some embodiments, the presence of the authorization code is the indication that the PEGC/UE is allowed to connect to the external network. In other embodiments, there is a separate indication and authorization code. The local node 152 has credentials to perform the secondary authentication with the PSP's external network 140, and the PSP has stored the information that local node 152 is allowed to use the PEGC/UE 110 with the authorization code.

In phase 210, an association exists between PEGC/UE 110 and core NW 130, according to normal cellular processes. This association continues throughout the illustrated process. In phase 220 local node 152 indicates to PEGC/UE 110 that it wishes to have a protocol session with application server 144 in external network 140. The PEGC/UE 110 requests the establishment of the protocol session towards external network 140 in phase 230. The core NW 130 responsively checks, in phase 240, whether the PEGC/UE 110 is allowed to connect to external network 140—if not, the request is rejected. Otherwise, a node in core NW 130 triggers secondary authentication.

In case message 230 did not comprise an identity of local node 152, core NW 130 queries this in phase 250. PEGC/UE 110 forwards the query to local node 152 in phase 260, and PEGC/UE 110 forwards the response 270 from local node 152 to core NW 130 in phase 280. The messages of phases 250-280 may comprise, for example, extensible authentication protocol, EAP, identity request and identity response messages, respectively.

In phase 290, core NW 130 informs external network 140, in particular the authentication server 142 therein, of the request to establish the protocol session. In phase 290, core NW 130 provides a code, e.g. an authorization code, from a subscription of PEGC/UE 110 that associates PEGC/UE 110 with a right to connect a local node with external network 140. This code may be conveyed by using an additional attribute value pair in a RADIUS or Diameter message, for example. In some embodiments, the code is associated specifically with an identity of local node 152 in combination with PEGC/UE 110 and their right to together access external network 140. In other embodiments, the code is associated with PEGC/UE 110 and its right to together access external network 140 for any local node. At least one authentication request/response exchange 295 is performed between authentication server 142 and local node 152, with PEGC/UE 110 relaying the messages to and from the local node. The local node 152 has authentication information with which it is able to respond to the authentication request. Cryptographic information, such as a shared key, may be established in local node 152 and authentication server 142 as a result of an authentication exchange 295. This information, or key, may be passed from authentication server 142 to application server 144.

In phase 2100, the authentication server 142 in external network 140 checks whether the code received in phase 290 is valid for PEGC/UE 110 in external network 140 and if local node 152 is allowed to use PEGC/UE 110 to access external network 140. If this is the case, authentication server 142 indicates to core NW 130 that the secondary authentication is acceptable, and core NW 130 may inform PEGC/UE 110 of this in phase 2120. The protocol session 2130 may then be established between local node 152 and application server 144 in external network 140, with PEGC/UE 110 acting as a relay. Protocol session 2130 may be secured, for example encrypted, based on the cryptographic information established as a result of authentication exchange 295, for example using the cryptographic information, or at least one key derived from the cryptographic information, as encryption key(s).

The authorization code may be a randomly generated number of suitable size, such as 128 bits or 256 bits, that is known only to the true owner of PEGC/UE 110, the cellular network operator and the PSP. The cellular network operator and the PSP are trusted service providers for the owner of PEGC/UE 110 and not expected to leak the authorization code to an attacker. The authorization code prevents an attacker from making use of a victim UE owner's PEGC/UE. While the attacker may be able to maliciously register a victim UE owner's PEGC/UE as the attacker's own PEGC in the attacker's PSP account, the attacker is not able to tell the PSP the authorization code the core NW will transmit to the PSP's authorization server in the secondary authentication process. In contrast, a true owner of a PEGC/UE is able to establish an authorization code with the cellular network operator, and this authorization code is stored in the subscription data of the PEGC/UE in the core NW and transmitted to the PSP's authentication server in secondary authentication, as described above. The true owner of the PEGC can further provide this authorization code to the PSP and the PSP can store it with authentication server 142, so that in a legal request, authentication server 142 can verify the authorization code received from the core NW 130.

An authorization code is valid for a single PSP. In scenarios with multiple PSPs, different authorization codes are used for different PSPs.

FIG. 2B illustrates an example process capable of supporting at least some embodiments of the present invention. The process is a more specific example of the process in FIG. 2A. Like numbering denotes like nodes as in FIG. 2A as the vertical axes. In detail, FIG. 2B has more detail in the core NW 130, wherein are present access and mobility management function/security anchor function AMF/SEAF 132, session management function, SMF, 134, user plane function, UPF, 136 and unified data management, UDM, node 138.

In phase 2140, an association exists between UE 110 and core NW 130, according to normal cellular processes. This is based on primary authentication, as was the case in FIG. 2A. This association continues throughout the process of FIG. 2B. In phase 2150, local node 152 indicates to PEGC/UE 110 that it wishes to have a protocol session with application server 144 in external network 140. The PEGC/UE 110 requests the establishment of the protocol session towards external network 140 in phase 2160 by signaling to AMF/SEAF 132. The AMF/SEAF 132 conveys this request onward inside core NW 130 to SMF 134 in phase 2170.

In phase 2180, SMF 134 obtains the PEGC/UE 110's subscription data, for example from UDM 138, and checks whether the request to open a protocol session to external network 140 is allowable, based on an indication in the subscription data. If this is allowed, SMF 134 initiates secondary authentication. If an identity of local node 152 was not provided in phases 2150 and 2160, SMF 134 queries this in phase 2190. PEGC/UE 110 forwards the query to local node 152 in phase 2200, and PEGC/UE 110 forwards the response 2210 from local node 152 to SMF 134 in phase 2220. The messages of phases 2190-2220 may comprise, for example, extensible authentication protocol, EAP, identity request and identity response messages. Local node 152 provides its identity to core NW 130 in the message exchange of phases 2190-2220.

Following the message exchange of phases 2190-2220, SMF 134 may establish an N4 session with UPF 136 in phase 2230, and SMF 134 provides the authorization code from PEGC/UE 110's subscription data concerning external network 140 to UPF in phase 2240. The message of phase 2240 may be of type EAP identity response, for example an EAP-response/identity message. In phase 2250, UPF 136 forwards the message of phase 2240 to authentication server 142 in external network 140, conveying here also the authorization code. An authentication request/response exchange 2255 is performed between authentication server 142 and local node 152, with PEGC/UE 110 relaying the messages to and from the local node. The local node 152 has authentication information with which it is able to respond to the authentication request.

In phase 2260, the authentication server 142 in external network 140 checks whether the code received in phase 2250 is valid for PEGC/UE 110 in external network 140 and if local node 152 is allowed to use PEGC/UE 110 to access external network 140. If this is the case, authentication server 142 indicates to UPF 136 that this is the case, phase 2270, and UPF 136 in turn forwards to SMF 134 the message of phase 2270 in phase 2280 and SMF 134 in turn informs PEGC/UE 110 of this in phase 2290. In phase 2300, the requested protocol session is in place, following the successful secondary authentication, between local node 152 and application server 144 in external network 140. Local node 152 and application server 144 are the only endpoints of this protocol session.

In FIGS. 2A and 2B, certain ones of the phases may take place in a different order from what is illustrated, as applicable.

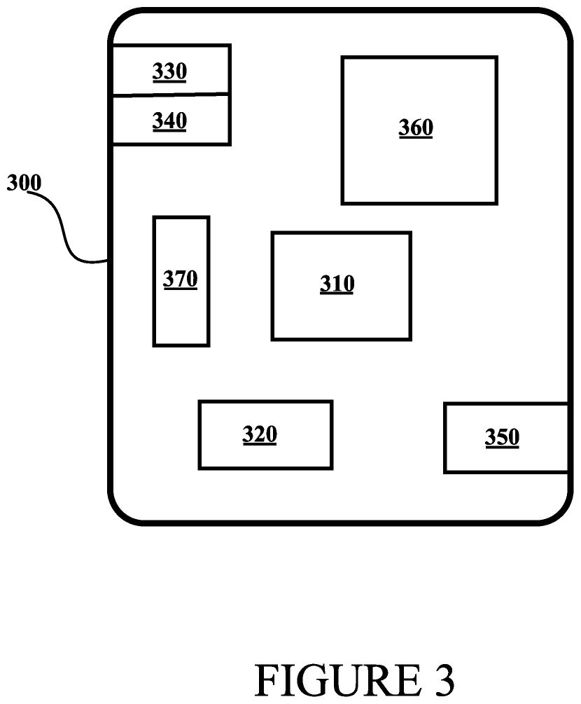

FIG. 3 illustrates an example apparatus capable of supporting at least some embodiments of the present invention. Illustrated is device 300, which may comprise, for example, a UE 110 of FIG. 1, an external-NW authentication server node, or a core-NW authentication node, such as SMF, as applicable. Comprised in device 300 is processor 310, which may comprise, for example, a single- or multi-core processor wherein a single-core processor comprises one processing core and a multi-core processor comprises more than one processing core. Processor 310 may comprise, in general, a control device. Processor 310 may comprise more than one processor. Processor 310 may be a control device. A processing core may comprise, for example, a Cortex-A8 processing core manufactured by ARM Holdings or a Zen processing core designed by Advanced Micro Devices Corporation. Processor 310 may comprise at least one Qualcomm Snapdragon and/or Intel Atom processor. Processor 310 may comprise at least one application-specific integrated circuit, ASIC. Processor 310 may comprise at least one field-programmable gate array, FPGA. Processor 310 may be means for performing method steps in device 300, such as transmitting, forwarding, relaying, performing, receiving and verifying. Processor 310 may be configured, at least in part by computer instructions, to perform actions.

A processor may comprise circuitry, or be constituted as circuitry or circuitries, the circuitry or circuitries being configured to perform phases of methods in accordance with embodiments described herein. As used in this application, the term “circuitry” may refer to one or more or all of the following: (a) hardware-only circuit implementations, such as implementations in only analogue and/or digital circuitry, and (b) combinations of hardware circuits and software, such as, as applicable: (i) a combination of analogue and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 300 may comprise memory 320. Memory 320 may comprise random-access memory and/or permanent memory. Memory 320 may comprise at least one RAM chip. Memory 320 may comprise solid-state, magnetic, optical and/or holographic memory, for example. Memory 320 may be at least in part accessible to processor 310. Memory 320 may be at least in part comprised in processor 310. Memory 320 may be means for storing information. Memory 320 may comprise computer instructions that processor 310 is configured to execute. When computer instructions configured to cause processor 310 to perform certain actions are stored in memory 320, and device 300 overall is configured to run under the direction of processor 310 using computer instructions from memory 320, processor 310 and/or its at least one processing core may be considered to be configured to perform said certain actions. Memory 320 may be at least in part comprised in processor 310. Memory 320 may be at least in part external to device 300 but accessible to device 300.

Device 300 may comprise a transmitter 330. Device 300 may comprise a receiver 340. Transmitter 330 and receiver 340 may be configured to transmit and receive, respectively, information in accordance with at least one cellular or non-cellular standard. Transmitter 330 may comprise more than one transmitter. Receiver 340 may comprise more than one receiver. Transmitter 330 and/or receiver 340 may be configured to operate in accordance with global system for mobile communication, GSM, wideband code division multiple access, WCDMA, 5G, long term evolution, LTE, IS-95, wireless local area network, WLAN, Ethernet and/or worldwide interoperability for microwave access, WiMAX, standards, for example.

Device 300 may comprise a near-field communication, NFC, transceiver 350. NFC transceiver 350 may support at least one NFC technology, such as NFC, Bluetooth, Wibree or similar technologies.

Device 300 may comprise user interface, UI, 360. UI 360 may comprise at least one of a display, a keyboard, a touchscreen, a vibrator arranged to signal to a user by causing device 300 to vibrate, a speaker and a microphone. A user may be able to operate device 300 via UI 360, for example to accept incoming telephone calls, to originate telephone calls or video calls, to browse the Internet, to manage digital files stored in memory 320 or on a cloud accessible via transmitter 330 and receiver 340, or via NFC transceiver 350, and/or to play games.

Device 300 may comprise or be arranged to accept a user identity module 370. User identity module 370 may comprise, for example, a subscriber identity module, SIM/USIM, card installable in device 300. A user identity module 370 may comprise information identifying a subscription of a user of device 300. A user identity module 370 may comprise cryptographic information usable to verify the identity of a user of device 300 and/or to facilitate encryption of communicated information and billing of the user of device 300 for communication effected via device 300.

Processor 310 may be furnished with a transmitter arranged to output information from processor 310, via electrical leads internal to device 300, to other devices comprised in device 300. Such a transmitter may comprise a serial bus transmitter arranged to, for example, output information via at least one electrical lead to memory 320 for storage therein. Alternatively, to a serial bus, the transmitter may comprise a parallel bus transmitter. Likewise, processor 310 may comprise a receiver arranged to receive information in processor 310, via electrical leads internal to device 300, from other devices comprised in device 300. Such a receiver may comprise a serial bus receiver arranged to, for example, receive information via at least one electrical lead from receiver 340 for processing in processor 310. Alternatively, to a serial bus, the receiver may comprise a parallel bus receiver.

Device 300 may comprise further devices not illustrated in FIG. 3. For example, where device 300 comprises a smartphone, it may comprise at least one digital camera. Some devices 300 may comprise a back-facing camera and a front-facing camera, wherein the back-facing camera may be intended for digital photography and the front-facing camera for video telephony. Device 300 may comprise a fingerprint sensor arranged to authenticate, at least in part, a user of device 300. In some embodiments, device 300 lacks at least one device described above. For example, some devices 300 may lack a NFC transceiver 350 and/or user identity module 370.

Processor 310, memory 320, transmitter 330, receiver 340, NFC transceiver 350, UI 360 and/or user identity module 370 may be interconnected by electrical leads internal to device 300 in a multitude of different ways. For example, each of the aforementioned devices may be separately connected to a master bus internal to device 300, to allow for the devices to exchange information. However, as the skilled person will appreciate, this is only one example and depending on the embodiment various ways of interconnecting at least two of the aforementioned devices may be selected without departing from the scope of the present invention.

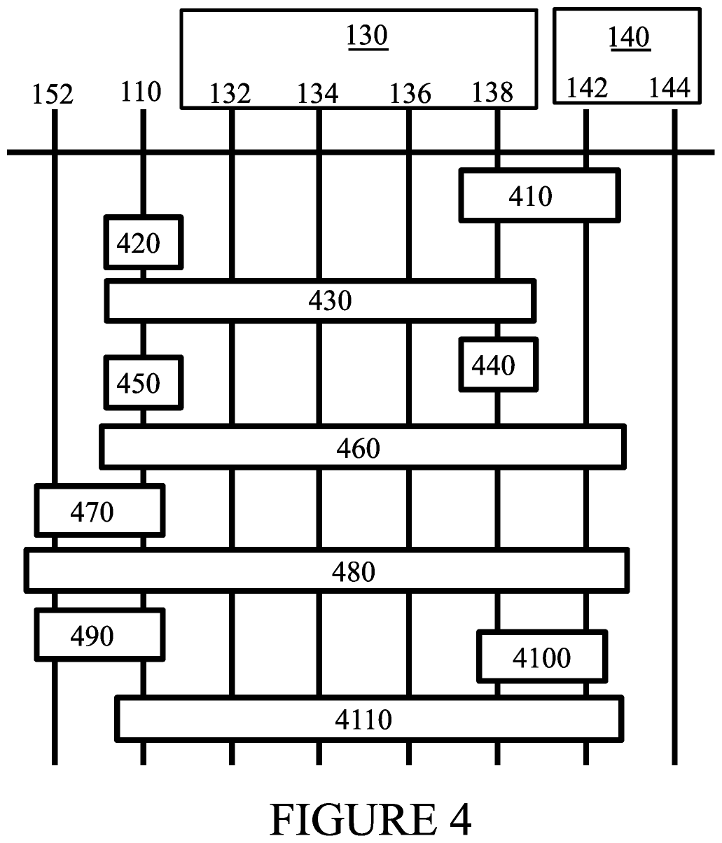

FIG. 4 illustrates signalling in accordance with at least some embodiments of the present invention. The vertical axes correspond to those of FIG. 2B. The process of FIG. 4 illustrates how the system may be initialized, such that the mechanism of FIG. 2A or 2B may be invoked.

In phase 410, an agreement is entered into between the PSP and cellular network concerning interworking of the two networks. In phase 420, the owner obtains the PEGC/UE 110, and subsequently in phase 430 he creates an account with the cellular operator, for example via an Internet portal, and registers his PEGC/UE 110 for use with PSP services in external NW 140. The authorization code may be established in this stage, and stored in the subscription data of PEGC/UE 110, or a subscription thereof. The authorization code may be stored in a memory accessible to the PEGC/UE 110 or its owner.

In phase 440, UDM 138 registers a policy according to which the PEGC/UE 110 is allowed to connect to external NW 140, and in phase 450 the owner takes the PEGC into use as a gateway node for his personal network of local nodes. Phase 460 comprises the owner registering the PEGC/UE 110 authorization code, which may have been established earlier in phase 430, with the PSP, for example via an Internet portal. The PSP stores the information of PEGC/UE 110 and the authorization code associated with their access to external network 140.

In phase 470, the owner activates local node 152, and in phase 480 registers the local node 152 with the PSP, for example via an Internet portal, informing the PSP that local node 152 is allowed to use PEGC/UE 110 to access NW 140. Credentials between the local node and PSP are either preconfigured, or configured during this step. In some embodiments, phase 480 is comprised in phase 460. In phase 490, local node 152 is taken into use. In some embodiments this phase is comprised in phase 470. In some embodiments, phase 490 is comprised in phase 470 and phase 480 is comprised in phase 460. If the user has several local nodes, phases 470-480 may be repeated for each one.

Subsequently, after successfully accessing external network 140 from local node 152 via PEGC/UE 110 and core NW 130, UDM 138 and authentication server 142 cooperate to define, phase 4100, charging information for the owner for traffic through core NW 130 to and from external NW 140 relating to PSP services. The billing is performed in phase 4110.

In practical terms, the PEGC/UE may be branded as belonging to a framework of the cellular operator, and local node 152 may be branded as belonging to a framework of the PSP of external NW 140. However this is not necessary, as interoperability between different operators may be achieved by acting according to, for example, the process illustrated in FIG. 4. Further, local nodes in the PIN of the owner may connect to other external networks than external network 140, operated by other PSPs. The owner already has an account with the cellular operator, and may use it to authorize the cellular operator to connect the PEGC/UE to an external NW of PSP2, distinct from the PSP of external NW 140, and establish an authorization code dedicated to PSP2. In phases 4100 and 4110 of FIG. 4, billing may also take place for PSP2, separate from the billing of the PSP of external NW 140.

A PIN may use several PEGCs, with one or more PSPs. Each single PEGC may be used for one or more PSPs, depending on how the devices are configured. Following the examples above, the owner performs the PEGC-related steps for each PEGC of registering the PEGC at the respective cellular operator and instructing the cellular operator to which external NWs the PEGC is allowed to connect, and registering the PEGC at the PSP(s) and instructing the PSP which local node(s) can connect to the PSP through this PEGC.

Local nodes may support only the application services of a single PSP. Alternatively, a local node may consist of hardware that supports running multiple applications, where each application may support the services of a different PSP. In this case, the applications may be registered with the respective PSP, rather than the local devices. The disclosed procedure is applicable, with an application making the connection request instead of the local node seen as a whole.

An PEGC/PIN owner may want to allow other parties to use the PEGC, with dedicated PSP accounts. For example in a residential scenario, several family members may have accounts with the same PSP, may have their own local devices and may want to use PSP services with these local devices without having each a dedicated PEGC. The owner may not want to share a single authorization code with multiple parties, but may prefer to have multiple authorization codes to share with other parties, so if an authorization code gets compromised, not all parties are affected. For this to work, the owner establishes with the cellular operator several authorization codes for the PSP that are all stored in the subscription data of the PEGC/UE. When a secondary authentication is carried out, the core NW does not transmit an authorization code to the PSP's external-NW authentication server. Instead, the PSP's authentication server, after successful secondary authentication in the external network, passes the authorization code to the core NW. The core NW then verifies that this authorization code is valid, that is, matches one of the authorization codes stored in the subscription data for this PSP. Only in this case, the core NW considers the secondary authentication as successful and proceeds to participate in establishing the protocol session.

Communication between local nodes and the PSP's external NW is secure due to mutual authentication with key establishment, and a transport or application layer security protocol built on this. Abuse of a PEGC for unauthorized connectivity is prevented as the PEGC cannot connect to arbitrary external NWs, but only to the ones it is authorized for according to the subscription data. A rogue local node cannot use an arbitrary PEGC to connect to a PSP's external network, but needs to be authorized to use it. Even if a local node has credentials for mutual authentication with the PSP's external network, the PSP's external network will only admit the local node when it uses a PEGC which the local node is authorized to use, that is, when the authorization code received from the core NW matches the one for which the local node has been registered at the PSP.

Secure connections to the PSP can be used to provide local nodes with credentials for secure direct communication, for example using the short range wireless connections. For example, the PSP could push down a group key to the local nodes to secure group communication. Another example is that local nodes could generate public/private key pairs, and the PSP creates and signs certificates for the public keys. These certificates can subsequently be used, for example, in a transport layer security, TLS, handshake between a pair of local nodes to secure direct one-to-one communication which does not traverse the PEGC.

The disclosed application layer security established by the disclosed procedure provides a reasonable layer of security even without additional link layer security measures within the PIN. Obviously, adding such link layer mechanisms appropriate for the applied link layer technology will improve the overall security posture of the PIN.

In prior solutions there is typically no specific support of PINs specified by 3GPP. Obviously, approaches like a mobile WLAN hotspot are possible. In that case, the cellular operator only provides connectivity—a single pipe from the UE to the Internet. All devices in the WLAN hotspot share the overall bandwidth and receive the same quality of service, QoS. Security must be configured and setup locally by the user. Security between devices and service providers must be added over-the-top, using mechanisms selected by such service providers. In contrast, according to the present disclosure, dedicated protocol sessions per local node are established, allowing to differentiate with respect to QoS parameters, for example. Connectivity can be restricted to a set of allowed PSP external NWs, preventing e.g. rogue Internet access. EAP may be used as a uniform authentication framework, but individual EAP authentication methods can be used. The cellular operator may be configured to support security setup. The cellular operator may be made aware of the traffic flows and can perform a PSP-specific metering. The billing of individual users can still be done, e.g. by the PSPs, depending of the selected business model and the contract between end user and PSP.

The proposed procedure applies the concept of secondary authentication to provide authentication between local nodes and a PIN application service provider. By separating and distributing the primary authentication, performed only by the PEGC, and the secondary authentication, performed only by the local node, both local nodes and the PEGC may be implemented in a lean way, without the burden to support multiple authentication mechanisms. Security is improved, as secrets belonging to different trust relationships need not be shared between devices—each device only has access to the information it needs. The separation also provides more flexibility, as new local nodes and new PSPs that may use arbitrary EAP-methods can be added without the need to touch the PEGC.

A high degree of protection against abuse of PINs by attackers is provided, firstly by restricting a PEGC to connect only to external NWs of the PSPs with which the owner has setup a contract, and secondly by binding local nodes to PEGCs and respective authorization codes. The approach further enables secure PIN usage without the need for the PO to configure local security mechanisms. Moreover, as the examples given above show, it enables scenarios where the owner does not need to be a subscriber of a specific cellular operator—the subscription can be part of the PEGC, and the owner only needs to instruct the respective cellular operator to which PSPs the PEGC is allowed to connect.

Thus, in summary the disclosed method provides a simple and user-friendly way to set up personal IoT networks, PINs, with cellular connectivity. At the same time the overall PIN approach assumed in this disclosure assigns an important role to the cellular operator in the value chain going beyond that of a pure connectivity provider.

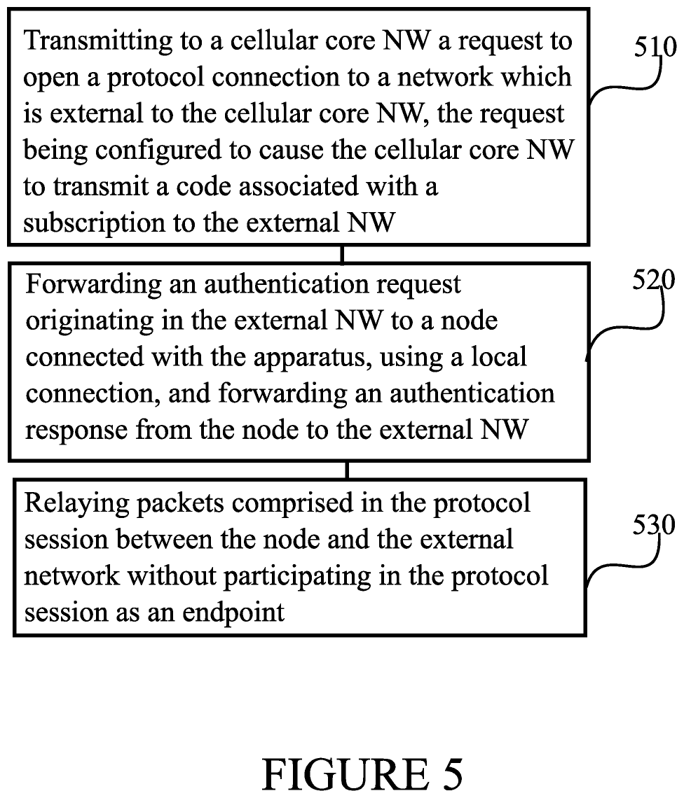

FIG. 5 is a flow graph of a method in accordance with at least some embodiments of the present invention. The phases of the illustrated method may be performed in PEGC/UE 110, for example, or in a control device configured to control the functioning thereof, when installed therein.

Phase 510 comprises transmitting, from an apparatus, to a cellular core network a request to open a protocol session to a network which is external to the cellular core network, the request being configured to cause the cellular core network to transmit a code associated with a subscription of the apparatus to the external network. Phase 520 comprises forwarding an authentication request originating in the external network to a node connected with the apparatus, via a local connection, and forwarding an authentication response from the node to the external network via the cellular core network. Finally, phase 530 comprises relaying packets comprised in the protocol session between the node and the external network without participating in the protocol session as an endpoint.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in interworking between networks.

1. An apparatus comprising:
at least one processor; and
at least one memory storing instructions that, when executed by the at least one processor, cause the apparatus at least to:
transmit to a core network a request to open a protocol session between a local node, connected to the apparatus via a local connection, and an external network that is external to the core network;
relay at least one message of a secondary authentication process between the local node and the external network via the core network, and
if the secondary authentication process is successful, relay packets comprised in a protocol session between the node and the external network without participating in the protocol session as an endpoint.

2. The apparatus of claim 1, comprising a user equipment (UE) of the core network.

3. The apparatus of claim 2, wherein the request is configured to cause the core network to inform the external network of the request to open a protocol session, and to transmit to the external network an authorization code associated with the UE indicating that the UE is allowed to connect to the external network.

4. The apparatus of claim 3, wherein the authorization code is not included in the request to open the protocol session and is not stored in the UE.

5. The apparatus of claim 2, wherein the protocol session is a packet data unit session, and wherein the packet data unit session is cryptographically protected using cryptographic information the UE does not store.

6. The apparatus of claim 2, wherein the apparatus is configured to transmit the request to open the protocol session as a response to a connection request message received from the local node.

7. The apparatus of claim 1, wherein the local connection comprises a short-range wireless connection.

8. The apparatus of claim 7, wherein the short-range wireless connection comprises a wireless local area network connection or a wireless connection between 2.402 GHz and 2.48 GHz.

9. A method comprising:
transmitting, to a core network, a request to open a protocol session between a local node, connected to a UE via a local connection, and an external network that is external to the core network;
relaying at least one message of a secondary authentication process between the local node and the external network via the core network, and
if the secondary authentication process is successful, relaying packets in a protocol session between the local node and the external network without participating in the protocol session as an endpoint.

10. The method of claim 9, performed by the UE of the core network.

11. The method of claim 9, wherein the request is configured to cause the core network to inform the external network of the request to open a protocol session, and to transmit to the external network an authorization code associated with the UE indicating that the UE is allowed to connect to the external network.

12. The method of claim 11, wherein the authorization code is not included in the request to open the protocol session and is not stored in the UE.

13. The method of claim 10, wherein the protocol session is a packet data unit session, and wherein the packet data unit session is cryptographically protected using cryptographic information the UE does not store.

14. The method of claim 9, wherein the local connection comprises a short-range wireless connection.

15. The method of claim 14, wherein the short-range wireless connection comprises a wireless local area network connection or a wireless connection between 2.402 GHz and 2.48 GHz.

16. An apparatus comprising:
at least one processor; and
at least one memory storing instructions that, when executed by the at least one processor, cause the apparatus at least to:
receive from a core network a message comprising an identity of a node connected to a user equipment (UE), and an authorization code associated with the UE;
verify, based on the authorization code, whether the node is allowed to access, via the UE, an external network that is external to the core network;
perform at least one authentication exchange with the node via the core network and the UE, and
if the node is allowed to access the external network via the UE, and the authentication exchange is successful, transmit an indication of authentication success to the core network.

17. The method of claim 16, performed by an authentication server of the external network.

18. An apparatus comprising:
at least one processor; and
at least one memory storing instructions that, when executed by the at least one processor, cause the apparatus at least to:
receive a request to open a protocol session to an external network that is external to a core network where the apparatus is comprised, the request identifying a user equipment (UE) of the core network;
verify, based on subscription data associated with the UE, whether the UE is allowed to act as gateway toward the external network;
if the UE is allowed to act as a gateway toward the external network, send an authorization code associated with the UE to an authentication server of the external network.

19. The method of claim 18, performed by an entity of the core network.
